(19) United States
(12) Patent Application Publication
(10) Pub. No.: US 2023/0032969 A1
(43) Pub. Date: Feb. 2, 2023

(54) METHOD FOR OPERATING A BRAKE SYSTEM, COMPUTER PROGRAM PRODUCT AND CONTROL UNIT

(71) Applicant: ZF Active Safety GmbH, Koblenz (DE)

(72) Inventor: Christoph Linden, Vallendar (DE)

(21) Appl. No.: 17/870,399

(22) Filed: Jul. 21, 2022

(30) Foreign Application Priority Data
Jul. 29, 2021 (DE) 102021119715.5

(51) Int. Cl. B60T 8/94; B60T 13/14; B60T 13/74; B60T 13/68; B60T 17/22

(52) U.S. Cl. CPC B60T 8/94; B60T 13/148; B60T 13/745; B60T 13/686; B60T 17/22; B60T 2270/406; B60T 2270/413

(57) ABSTRACT

A method for operating a brake system of a motor vehicle is disclosed, wherein the brake system comprises a drive arrangement for driving at least one actuating device designed to actuate a hydraulic pressure generator. The drive arrangement has an electric drive. The hydraulic pressure generator is designed to build up a hydraulic pressure on at least one wheel brake of the motor vehicle. The method comprises the steps of: monitoring the drive arrangement and/or brake system to detect a state, such as an error state, of the drive arrangement and/or brake system; detecting a state, such as an error state, of the drive arrangement and/or brake system; and controlling the hydraulic pressure based on the detected state, such as an error state. A computer program product and control unit or system having multiple control units is also disclosed.

### CROSS-REFERENCE TO RELATED APPLICATION

This application claims priority to German Patent Application No. 102021119715.5, filed Jul. 29, 2021, the disclosure of which is incorporated herein by reference in its entirety.

### TECHNICAL FIELD

The disclosure relates to a method for operating a brake system, a computer program product and a control unit and a system comprising multiple control units for a motor vehicle.

### BACKGROUND

In vehicle brake systems, electromechanical brake boosters (electronic brake booster, EBB actuators) are often used, which support the pressure exerted on the master brake cylinder. In the case of electromechanical brake boosters, the auxiliary energy is generated electrically. By way of example, the piston of the master brake cylinder is moved by an electric motor and a gear. Such an electromechanical brake booster is known for example from EP 3 350 046 B1 and a method for controlling a brake actuation is known from EP 2 379 378 B1.

However, the known systems have the disadvantage that, with a high brake pressure which is generated by the electromechanical brake booster and a failure or defect of the electrical support, the hydraulic pressure abruptly pushes the piston of the master brake cylinder directly in the reverse direction, whereby, via the gear, the electric motor is rotated in the reverse direction in a mechanically accelerated manner at a high rotational speed via the hydraulic pressure. Owing to the mechanical design of the electromechanical brake booster, this can result in the rack in the actuator moving at high speed onto the back stop. It has been shown that the mechanical construction may not be stable enough to withstand this impulse or impact. For example, gearwheels, the rack or the housing base may be damaged or even destroyed. This may then result in a failure of the electromechanical brake booster.

### SUMMARY

The disclosure is based on functionally improving a method mentioned at the outset. Moreover, the disclosure is based on structurally and/or functionally improving a computer program product mentioned at the outset and a control unit or control system mentioned at the outset.

A method may be and/or serve for operating a brake system of a motor vehicle. The brake system may be a motor vehicle brake system. The brake system may comprise a drive arrangement for driving at least one actuating device designed to actuate a hydraulic pressure generator. The brake system may comprise the hydraulic pressure generator. The brake system may comprise the actuating device. The brake system may comprise at least one wheel brake. Instead of the term “wheel”, the term “tire” may be used above and/or below. The motor vehicle may be a car or a heavy goods vehicle. The brake system may have a functional unit. The functional unit may have a brake pedal which can be actuated by a driver of the vehicle. The functional unit may have the hydraulic pressure generator.

The hydraulic pressure generator may be, for example operatively, such as mechanically and/or electrically, coupled to the brake pedal. The hydraulic pressure generator may be designed to build up a hydraulic pressure on the at least one wheel brake. The at least one wheel brake may be hydraulically actuable. The hydraulic pressure generator may be designed to build up a hydraulic pressure on multiple, for example two, three or four, wheel brakes The hydraulic pressure may be a hydraulic fluid pressure and/or brake pressure. The hydraulic pressure generator may comprise or be a brake cylinder. The brake cylinder may be a master brake cylinder, for example a tandem master brake cylinder. The brake cylinder may be operatively, for example mechanically and/or electrically, coupled to the brake pedal. The brake system and/or the hydraulic pressure generator may have a hydraulic fluid reservoir. The hydraulic pressure generator and/or the brake cylinder may have a piston, such as an input piston, master cylinder piston, master brake cylinder piston or master cylinder tandem piston. The brake pedal may be designed to mechanically actuate the brake cylinder and/or piston. The piston may be a tandem piston. The piston may be operatively, for example mechanically and/or electrically, coupled to the brake pedal.

The drive arrangement may have an electric drive. The electric drive may be and/or comprise at least one electric motor and/or at least one electric synchronous machine, such as a permanent-magnet synchronous machine (PMSM). The drive arrangement may have at least one gear. The gear may have multiple gearwheels. The gear may be designed to couple the electric drive to the at least one actuating device. The gear may be or become coupled to the at least one actuating device. The at least one actuating device may be or become indirectly or directly coupled to the hydraulic pressure generator, for example to the piston of the hydraulic pressure generator. The drive arrangement may be designed to displace or to move the piston, for example upon manual and/or automatic activation of a braking procedure and/or vehicle-stopping function and/or during the braking operation of the motor vehicle. The piston which can be displaced or moved by the drive arrangement may be a master cylinder piston, such as a master brake cylinder piston, or a piston which is indirectly or directly coupled or couplable to the master cylinder piston. The indirect action may take place for example in a hydraulic manner in that the gear acts on a plunger arrangement whereof the output may be hydraulically coupled to an input of the brake cylinder. The drive arrangement may be an electromechanical brake booster (electronic brake booster, EBB actuator).

The brake cylinder of the hydraulic pressure generator may have a pressure chamber. The piston may be mounted in the pressure chamber. Via a displacement of the piston in the pressure chamber of the brake cylinder, the hydraulic pressure in the pressure chamber and/or the pressure in fluid lines which are in communication, or can be brought into communication, with the pressure chamber may be altered. The pressure chamber may be or become fluidically coupled to one or more wheel brakes via the fluid lines. The hydraulic pressure in the pressure chamber may be transferred to the one or more wheel brakes as a brake pressure.

The brake system may have a wheel-brake-pressure regulating device. The wheel-brake-pressure regulating device may be designed to carry out regulating interventions on the at least one wheel brake of the motor vehicle. The wheel-brake pressure regulating device may be designed to regulate the hydraulic pressure or brake pressure on one or more wheel brakes via a brief successive sequence of pressure-maintaining, pressure build-up and/or pressure-decrease phases, for example in order to prevent a locking or spinning of one or more wheels of the vehicle. The brake system and/or the wheel-brake-pressure regulating device may have one or more valve arrangements/valves and/or pump devices/pumps. The wheel-brake-pressure regulating device may have a hydraulic fluid reservoir. The brake system and/or the wheel-brake-pressure regulating device may have at least one reservoir, such as a fluid reservoir and/or hydraulic reservoir and/or pressure reservoir. The at least one reservoir may be a low-pressure reservoir (low pressure accumulator, LPA).

The brake system may comprise a vehicle-dynamics regulating system, for example an anti-lock brake system (ABS) and/or an electronic stability program (ESP or ESC, electronic stability control). The vehicle-dynamics regulating system may comprise one or more functions, such as anti-slip regulation (ASR), an anti-lock brake system (ABS) and/or an electronic brake force distribution (EBV). The brake system may comprise a traction control system (TC). The brake system may be designed as a brake by wire system (BBW system). The brake system may be fitted with an electric brake boost system (EBB system) and/or designed as such. The drive arrangement and/or the hydraulic pressure generator may be part of the electric brake boost system. In the case of the EBB system, the force applied to the brake pedal by the driver may be boosted by the drive arrangement. The wheel-brake-pressure regulating device may be and/or comprise a vehicle safety system and/or vehicle dynamics regulating system, for example an ABS and/or TC and/or ESC regulating device.

The method may comprise the step: monitoring the drive arrangement and/or brake system to detect a state of the drive arrangement and/or brake system. The state may be an error state and/or operating state. The error state may be a state, such as an error state and/or operating state, of the electric drive of the drive arrangement. The monitoring may take place by a monitoring device, for example a so-called watchdog device. The monitoring device may have one or more sensors in order to record the state. The monitoring device may be part of the brake system and/or a control unit or control unit system.

The state, such as an operating state and/or error state, may be based on a failure and/or defect of a control module and/or control unit and/or control unit system. The state, such as an operating state and/or error state, may be based on a failure and/or defect of the drive arrangement and/or the electric drive thereof, such as an electric motor and/or the electric synchronous machine and/or gear. The state, such as an operating state and/or error state, may be based on a failure and/or defect of, in particular electronic, components, such as transistors, for example of a control unit. The state, such as an operating state and/or error state, may be based on a failure and/or defect of drivers, such as bridge drivers. The state, such as an operating state and/or error state, may be based on a failure and/or defect of sensor signals. For example, on one or more false sensor signals. The sensor signals may originate from, and/or be recorded by, sensors of the brake system and/or the drive arrangement. A sensor signal may be for example a position signal, drive position signal, motor position signal, for example of the electric motor and/or the electric synchronous machine of the drive arrangement.

The method may comprise the step: detecting the state, such as an operating state and/or error state, of the drive arrangement and/or brake system. The detection procedure may be or comprise a recording of the state. One or more states, for example of various components, of the drive arrangement and/or brake system, may be recorded and/or detected. In particular, the state, such as an operating state and/or error state, of the electric drive of the drive arrangement may be recorded and/or detected. A current state, such as a current operating state and/or current error state, of the drive arrangement and/or brake system may be recorded and/or detected. For example, the current state, such as a current operating state and/or a current error state, of the electric drive of the drive arrangement may be recorded and/or detected. The current state may be compared to a predefined state. On the basis of the comparison, it may be detected whether or not an error state exists.

The method may comprise the step: controlling the hydraulic pressure based on the detected state, for example based on the detected error state and/or operating state. The control of the hydraulic pressure may, for example only, take place when it has been detected that an error state exists or is present.

In the case of a detected error state, if it has been detected that an error state exists or is present, the currently prevailing hydraulic pressure may be maintained. For example, the prevailing hydraulic pressure may be kept constant. Hydraulic pressure may be understood to mean the hydraulic pressure generated by the hydraulic pressure generator. The maintaining of the hydraulic pressure may take place by controlling, in particular closing, one or more valve arrangements and/or at least one valve, such as a holding valve, for example of the brake system and/or the wheel-brake-pressure regulating device.

In the case of a detected error state, in particular if it has been detected that an error state exists or is present, the hydraulic pressure may be decreased or reduced in a controlled manner. The decrease or reduction of the hydraulic pressure may take place by controlling, in particular opening, one or more valve arrangements and/or at least one valve, such as a holding valve, for example of the brake system and/or the wheel-brake-pressure regulating device. The decrease or reduction of the hydraulic pressure may take place by controlling one or more pump devices and/or at least one pump, for example of the brake system and/or the wheel-brake-pressure regulating device. The decrease or reduction of the hydraulic pressure may take place by pumping hydraulic fluid into a hydraulic reservoir, such as a low pressure reservoir.

In the case of a detected error state, if it has been detected that an error state exists or is present, the hydraulic pressure may firstly be maintained, for example as described above and/or below, and then controlled, for decreased or reduced, for example as described above and/or below.

In the case of a detected error state, if it has been detected that an error state exists or is present, a switch from a first sensor signal to a second sensor signal may take place and/or the drive arrangement and/or the electric drive thereof may be regulated based on the second sensor signal. The first sensor signal may be a first position signal, such as a first drive position signal and/or first motor position signal, of the electric drive of the drive arrangement, such as the electric motor and/or the electric synchronous machine. The second sensor signal may be a second position signal, such as a second drive position signal and/or second motor position signal, of the electric drive of the drive arrangement, such as the electric motor and/or the electric synchronous machine. The first sensor signal may be recorded and/or provided by a first sensor. The second sensor signal may be recorded and/or provided by a second sensor. The scanning rate of the first sensor may be lower than the scanning rate of the second sensor.

In the case of a detected error state, in particular if it has been detected that an error state exists or is present, the hydraulic pressure may firstly be maintained, for example as described above and/or below, and then, after reaching a drive speed of the drive arrangement, the electric drive of the drive arrangement, of substantially zero or precisely zero, a switch from a first sensor signal to a second sensor signal may take place and/or in particular the drive arrangement and/or the electric drive thereof may be regulated based on the second sensor signal. The drive speed may be monitored and/or recorded. The drive speed may be the speed of the electric motor and/or the electric synchronous machine. The drive speed may be the motor speed or electric motor speed. The first sensor signal and/or the second sensor signal may be the first sensor signal and/or second sensor signal described above and/or below. After the switch to the second sensor signal, the one or more valve arrangements and/or the at least one valve, such as a holding valve, for example of the brake system and/or the wheel-brake-pressure regulating device, may be opened again and/or the drive arrangement and/or the electric drive thereof may be regulated based on the second sensor signal.

As a result of opening the one or more valve arrangements and/or the at least one valve and/or as a result of pumping hydraulic fluid into the low-pressure reservoir, the electric drive of the drive arrangement may be reversed in a slow and/or controlled manner.

As a result of opening the one or more valve arrangements and/or the at least one valve, the hydraulic fluid may be released again. The hydraulic pressure generator and/or the drive arrangement or the electric drive thereof may then influence or control the hydraulic pressure again.

A computer program product may comprise program code in order to execute the method described above and/or below, for operating a brake system, when the computer program product is executed on a processor. A computer program product may prompt a device, such as a, for example electronic, control and/or a control and/or computing module/unit, a control system, a driver assistance system, a brake system, such as a vehicle brake system, a processor or a computer, to execute the method described above and/or below, for operating a brake system. To this end, the computer program product may have corresponding data sets and/or program code and/or the computer program and/or a storage medium for storing the data sets or the program.

A control unit or a system comprising multiple control units may be used in a motor vehicle. The brake system and/or the electromechanical brake booster (EBB actuator/EBB system) may comprise the control unit or the system comprising multiple control units.

The control unit or the system may be developed and intended for use in a motor vehicle. The control unit or the system may have an electronic control. The control unit or the system may be or comprise an electronic control unit (ECU). Multiple control units may be provided. The multiple control units may be connected and/or exchange data with one another via a bus system, for example a controller area network (CAN). The electronic control and/or the control unit or system may have a microcomputer and/or processor. The control unit or system may comprise one or more sensors. The control unit or system may comprise the computer program product described above and/or below. The control unit or the system may have a memory. The computer program product may be stored in the memory. The control unit or system may be designed to carry out the method described above and/or below.

In other words, EBB actuator component protection or EBB motor regulation may be provided. In the case of a brake system, this may refer to a 2 box design. The vehicle stability control (VSC) may cooperate with the electromechanical brake booster (electronic brake booster, EBB actuator). In the event of an error (e.g. a defect of the ECU, the motor, of FETs, of bridge drivers etc.) of the EBB system, the VSC unit may close ABS holding valves. The pressure, such as a hydraulic pressure, may thus be confined or maintained or kept constant. The motor of the EBB actuator would not be accelerated or would only be slightly accelerated. The pressure, such as a hydraulic pressure, may then be decreased via the VSC unit, for example by pumping the hydraulic fluid into a low-pressure reservoir (low pressure accumulator, LPA) and/or by a controlled discharge via the ABS holding valves, so that the motor of the EBB actuator may be reversed in a slow and controlled manner. In this case, the brake pressure may also decrease in a slow and/or controlled manner. In the case of an error caused by a defective or false motor position signal, of the motor of the EBB actuator, a switch from a first sensor, such as a first motor position sensor (MPS1), to a second sensor, such as a second motor position sensor (MPS2), may take place. The scanning rate of the first sensor may be lower than the scanning rate of the second sensor. By virtue of operation of the VSC unit, the pressure, such as a hydraulic pressure, may also firstly be closed off here and, with a motor speed of zero, a switch to the second sensor MPS2 may take place and the valves are then opened again. Reliable switching to the second sensor info may thus be ensured. The EBB actuator and/or the motor thereof may now be regulated again using the second sensor info MPS2.

By the disclosure, the electric drive, in particular the electric motor, of the electromechanical brake booster (EBB actuator/EBB system) may be reversed in a controlled and safe manner. An uncontrolled backwards impact may be prevented. Damage or destruction of the electromechanical brake booster or parts thereof may be prevented. The safety may be increased. The reliability may be improved.

### BRIEF DESCRIPTION OF DRAWINGS

Exemplary arrangements of the disclosure are described in more detail below with reference to figures in which, in a schematic representation and by way of example:

FIG. 1 shows a flow chart of a method for operating a brake system of a motor vehicle; and

FIG. 2 shows a control unit.

### DETAILED DESCRIPTION

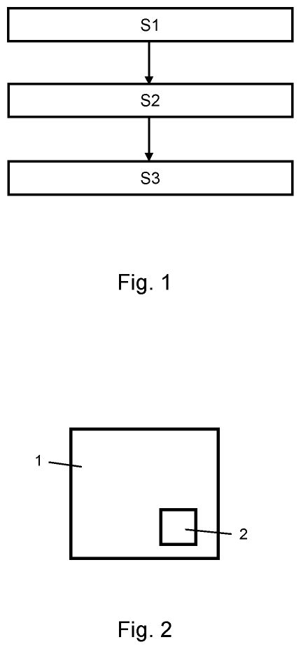

FIG. 1 shows, in a schematic representation, a flow chart of a method for operating a brake system of a motor vehicle.

The brake system has a drive arrangement for driving at least one actuating device designed to actuate a hydraulic pressure generator. The drive arrangement has an electric drive, such as an electric motor, and a gear. The hydraulic pressure generator is designed to build up a hydraulic pressure on at least one wheel brake of the motor vehicle.

In a step S1, the drive arrangement and/or brake system is monitored to detect a state, such as an error state, of the drive arrangement and/or brake system.

In a step S2, a state, such as an error state, of the drive arrangement and/or brake system is detected and/or recorded.

In a step S3, the hydraulic pressure is controlled based on the detected state, such as an error state. In the case of a detected error state, the hydraulic pressure is hereby firstly maintained, for example by closing at least one valve, such as a holding valve, and then controlled, in particular decreased or reduced by opening the at least one valve and/or by pumping hydraulic fluid into a low-pressure reservoir. The electric drive of the drive arrangement may thus be reversed in a slow and controlled manner and damage or destruction caused by an abrupt reversal of the piston of the hydraulic pressure generator owing to the hydraulic pressure may therefore be prevented.

FIG. 2 shows, in a schematic representation, a control unit 1, which is developed and intended for use in a motor vehicle. The control unit 1 has a processor 2 and a computer program product. The computer program product comprises a program code to carry out the method described above and/or below when the computer program product is executed on the processor 2.

Moreover, please refer additionally to FIG. 1 and the associated description.

The word “may” refers in particular to optional features of the disclosure. Consequently, there are also developments and/or exemplary arrangements of the disclosure which additionally or alternatively have the respective feature or the respective features.

Isolated features may also be extracted as required from the feature combinations disclosed in the present case and, by eliminating a structural and/or functional connection which is possibly present between the features, may be used in combination with other features to define the subject matter of a claim. The sequence and/or number of all steps of the method may be varied.

1. A method for operating a brake system of a motor vehicle, wherein the brake system comprises a drive arrangement for driving at least one actuating device designed to actuate a hydraulic pressure generator, wherein the drive arrangement has an electric drive and the hydraulic pressure generator is designed to build up a hydraulic pressure on at least one wheel brake of the motor vehicle, wherein the method comprises the steps:
monitoring the drive arrangement and/or brake system to detect a state of the drive arrangement and/or brake system;
detecting a state of the drive arrangement and/or brake system; and
controlling the hydraulic pressure based on the detected state.

2. The method according to claim 11, wherein, in the case of a detected error state, the currently prevailing hydraulic pressure is maintained by closing at least one valve.

3. The method according to claim 1, wherein,
in an event of a detected error state, the hydraulic pressure
is decreased or reduced by opening the at least one valve and/or by pumping hydraulic fluid into a low-pressure reservoir.

4. The method according to claim 1, wherein,
in an event of a detected error state, the hydraulic pressure is firstly maintained by closing at least one valve, and then controlled, in particular decreased or reduced by opening the at least one valve and/or by pumping hydraulic fluid into a low-pressure reservoir.

5. The method according to claim 1, wherein,
in a case of a detected error state, a switch from a first sensor signal, to a second sensor signal, takes place and/or the drive arrangement is regulated based on the second sensor signal.

6. The method according to claim 1, wherein
in a case of a detected error state, the hydraulic pressure
is firstly maintained by closing at least one valve, and then, after reaching a drive speed, of the drive arrangement, of substantially zero, a switch from a first sensor signal, to a second sensor signal, takes place.

7. The method according to claim 6, wherein, after the switch to the second sensor signal, the at least one valve is opened again and/or the drive arrangement is regulated based on the second sensor signal.

8. The method according to claim 11, wherein
the error state is based on a failure and/or defect of a control unit and/or the drive arrangement and/or the electric drive thereof, and/or of, electronic components, and/or of sensor signals.

9. A computer program, comprising a program code to carry out a method according to claim 1, when the computer program is executed on a processor.

10. A control unit or system comprising multiple control units for a motor vehicle, comprising at least one processor and the computer program according to claim 9.

11. The method according to claim 1, wherein the state monitored and detected is an error state.

12. The method according to claim 2, wherein the at least one valve is a holding valve.

13. The method according to claim 5, wherein the first signal is a first motor position signal and the second signal is a second motor position signal.
